(19) United States
(12) Patent Application Publication
(10) Pub. No.: US 2017/0218233 A1
(43) Pub. Date: Aug. 3, 2017

(54) A PRESSURE SENSITIVE ADHESIVE TAPE

(71) Applicants: TMSCHEMICAL CO. LTD., Goyang-si (KR); STI CO., LTD., Bucheon-si (KR)

(72) Inventors: Chang Yong LEE, Hwaseong-si (KR); Ki-Sang MOON, Goyang-si (KR)

(21) Appl. No.: 14/655,624

(22) PCT Filed: May 13, 2015
(86) PCT No.: PCT/KR2015/004800

§ 371 Date: Jun. 25, 2015

(30) Foreign Application Priority Data
Apr. 29, 2015 (KR) 10-2015-0060570

(51) Int. Cl. C09J 7/02; B32B 25/14; B32B 7/12

(52) U.S. Cl. CPC C09J 7/0271; C09J 7/0246; B32B 7/12; B32B 25/14; C09J 109/06

(57) ABSTRACT

The pressure sensitive adhesive tape is superior in moisture resistance because of its high peel strength and is easy to peel from an adherend by including a filler in the adhesive layers.

### TECHNICAL FIELD

The present invention relates to a pressure sensitive adhesive tape that is superior in resistance to moisture because of its high peel strength and is easy to peel from an adherend.

### BACKGROUND OF THE INVENTION

Pressure sensitive adhesive tape means a tape that is prepared by using a material maintaining its sticky nature permanently unless its surface is contaminated and is capable of adhering to an adherend easily by a tiny pressure such as a finger pressure at room temperature.

Such pressure sensitive adhesive tape is widely used in very various fields about daily supplies, cars, flights, IT industry, and so on. Particularly, in IT industry field, it is used for transporting semiconductors, mobile phones, displays, precision products, and so on, or for fixing and protecting materials.

The pressure sensitive adhesive tape must be peeled easily as well as have an adhesive power enough to adhere to an adherend, and it must not leave residue on the adherend surface. Particularly, the pressure sensitive adhesive tape is peeled by a stretch method and is generally peeled by the force stronger than the adhesive power. Therefore it must endure the force stronger than the adhesive power. The adhesive power of the pressure sensitive adhesive tape is referred to as peel strength, and the non-breaking property by a stretch is referred to as tear strength.

With regard to this, U.S. Pat. Nos. 5,491,012 and 5,409,189 disclose the pressure sensitive adhesive tape of which the ratio of the peel strength and the tear strength is 1:1.5 or more. According to this, they disclose that the pressure sensitive adhesive tape is easily peeled because the adhesive power thereof decreases when the film is pulled in the direction parallel to the adherend surface. However, there is a limitation in increasing the peel strength, because the tear strength of the pressure sensitive adhesive tape increases if the peel strength increases and it takes a lot of force to elongate the film.

Meanwhile, the pressure sensitive adhesive tape is usually used in a moist circumstance like a bathroom, for example, the pressure sensitive adhesive tape may be attached to the bathroom wall for fixing a hook for a towel or cloths. At this time, a method of using a primer having water-proof function together has been used because moisture is a main factor to decrease the adhesive power of the pressure sensitive adhesive tape, but it has a disadvantage of causing an inconvenience of users.

In order to increase the moisture resistance of the pressure sensitive adhesive tape, a method of increasing the adhesive power, namely, the peel strength, of the same was suggested. However, there is a problem of that it is difficult to peel the pressure sensitive adhesive tape when the adhesive power is increased because there is a correlation between the adhesive power for adhering the pressure sensitive adhesive tape to the adherend and the stretching force for peeling the same. Therefore, it is required to develop the pressure sensitive adhesive tape which has increased adhesive power but is easy to be peeled.

### DETAILS OF THE INVENTION

### Objects of the Invention

The present invention relates to a pressure sensitive adhesive tape that is superior in resistance to moisture because of its high peel strength and is easy to peel from an adherend, and a preparation method thereof.

### Means for Achieving the Object

To resolve the problem, the present invention provides a pressure sensitive adhesive tape comprising a substrate layer and adhesive layers laminated on both faces of the substrate layer,

wherein the thickness of the substrate layer is 25 μm to 500 μm and the substrate layer comprises a thermoplastic synthetic rubber and a reinforcement,

the thickness of each adhesive layers is 10 μm to 240 μm respectively and the substrate layer comprises a thermoplastic synthetic rubber and a filler,

the filler is a particle having the diameter of 0.01 μm to 120 μm, and

the peel strength of the pressure sensitive adhesive tape is 6,000 to 25,000 gf/20 mm.

The term ‘pressure sensitive adhesive tape’ used in the present invention means a tape that is prepared by using a material maintaining a sticky nature permanently unless its surface is contaminated and is capable of adhering to an adherend easily by a tiny pressure such as a finger pressure at room temperature. The pressure sensitive adhesive tape of the present invention is characterized in that it does not involve a chemical reaction with the surface of the adherend unlike common adhesion, and thus it can be easily eliminated from the adherend with necessity.

The pressure sensitive adhesive tape according to the present invention comprises the adhesive layers laminated on both faces of the substrate layer, and the higher adhesive power of the adhesive layer, the better, because the characteristic that the pressure sensitive adhesive tape adheres to the adherend and maintains the state relates to the adhesive power of the adhesive layer. Another advantage of high adhesive power is that the resistance to moisture increases. When the pressure sensitive adhesive tape is used in a circumstance like a bathroom, it may contact with moisture and there is a problem of decreasing the adhesive power. However, if the adhesive power of the adhesive layer is high, the pressure sensitive adhesive tape can sufficiently adhere to the adherend and maintain the state even when it contacts with moisture.

Meanwhile, a method of stretching the pressure sensitive adhesive tape is used when the pressure sensitive adhesive tape is eliminated from the adherend. When the pressure sensitive adhesive tape according to the present invention is stretched in the direction substantially parallel to the adherend surface, namely, in the direction substantially parallel to the longitudinal direction of the pressure sensitive adhesive tape, the sections where the surface area of the pressure sensitive adhesive tape widens and the adhesive power decreases locally are generated and the exfoliation occurs as the process occurs continuously. At this time, the force for stretching the pressure sensitive adhesive tape relates to the adhesive power and the elasticity of the pressure sensitive adhesive tape itself.

Generally, it is known that the force larger than the adhesive power is need for eliminating the pressure sensitive adhesive tape from the adherend by a stretch method. Therefore, there is a problem of that the force needed for eliminating the pressure sensitive adhesive tape from the adherend increases as the adhesive power increases. Accordingly, it is required to develop a pressure sensitive adhesive tape which has high adhesive power and can be easily eliminated from the adherend by a stretch method, in other words, which can be eliminated from the adherend by a stretch method with lesser force than the adhesive power.

Meanwhile, a method of selecting the material of the adhesive layer properly or increasing the amount of a tackifier used may be used for increasing the adhesive power, but it is not enough simply to change the material of the adhesive layer itself for satisfying said condition.

Therefore, the present invention is based on the fact that the pressure sensitive adhesive tape can be easily eliminated from the adherend by thinning the thickness of the adhesive layer or increasing the surface area thereof when the pressure sensitive adhesive tape is stretched, and it is characterized in that the adhesive layer comprises a filler.

The term ‘filler’ in the present invention means a particle having the diameter of 0.01 μm to 120 μm, which is included in the adhesive layer and has a solid characteristic unlike the thermoplastic synthetic rubber in the adhesive layer, and thus it has a characteristic of maintaining the shape even when the pressure sensitive adhesive tape is stretched.

As schematically illustrated in FIG. 1, the adhesive layer 1 of the present invention comprises the filler 2 (FIG. 1(a)), and, when the pressure sensitive adhesive tape is stretched, the adhesive layer is also stretched and the thickness of the adhesive layer becomes thin (FIG. 1(b)). At this time, the filler 2 protrudes from the surface of the adhesive layer while the thickness of the adhesive layer 1 is thinning because the filler 2 maintains its shape even when the adhesive layer 1 is stretched. Accordingly, the thickness of the adhesive layer becomes thinner locally or the surface of the adhesive layer becomes bumpy, and thus the pressure sensitive adhesive tape can be easily removed from the adherend.

The kind of the filler is not limited particularly if it can maintain the shape even when the adhesive layer is stretched and, preferably, it may be made of a glass, a metal, an inorganic particle, aluminium hydroxide, polyethylene, or polypropylene. For specific examples of the filler, glass beads, glass bubbles, hollow glass microspheres (Q-Cel 5020 of Potters Industries Co., Ltd. for a commercial example), ultra high molecular weight polyethylene (UHMW-PE, GUR 2126 of Celanese Co., Ltd. for a commercial example), aluminum hydroxide (BF-083 of Nippon Light Metal Co., Ltd. for a commercial example), and so on may be used.

The content of the filler may be preferably 5 to 15 wt % per the total weight of the adhesive layer.

Furthermore, it is possible to reduce the peel strength while maintaining the adhesive power of the pressure sensitive adhesive tape by adding the filler. The peel strength of the pressure sensitive adhesive tape may be 6,000 to 25,000 gf/20 mm, and preferably 10,000 to 24,000 gf/20 mm, 15,000 to 23,000 gf/20 mm, or 16,000 gf/20 mm to 20,000 gf/20 mm.

The peel strength may be measured by the method of: cutting the pressure sensitive adhesive tape with the width of 20 mm, attaching a PET film of 25 μm thickness to the opposite face of the measuring face, attaching the film to a SUS adherend and pressing the same by rolling a 2 kg roller back and forth once thereon, and, after 30 mins, measuring the peel strength by peeling the film with the speed of 300 mm/min in the direction vertical to the adherend. As disclosed above, higher peel strength is preferable because not only the adhesive power to the adherend increases but also the moisture resistance increases.

Further, the pressure sensitive adhesive tape according to the present invention has high peel strength and can be easily eliminated as disclosed above. The stretch release strength of the pressure sensitive adhesive tape according to the present invention may be 3,000 gf or less, preferably 2,000 to 3,000 gf, and more preferably 2,500 to 2,900 gf.

The stretch release strength may be measured by the method of: cutting the pressure sensitive adhesive tape into the size of 20 mm×60 mm, attaching glass adherends to both sides of the measuring part of 20 mm×40 mm, and, after 30 mins, pulling the upper part (20 mm×20 mm) of the pressure sensitive adhesive tape for peeling the same.

According to one embodiment of the present invention, it is recognized that the pressure sensitive adhesive tape comprising the filler has no meaningful difference in the peel strength but the stretch release strength of the same decreases about 15 to 20% in comparison with the pressure sensitive adhesive tape that does not include the filler. Therefore, it is possible to increase not only the moisture resistance by increasing the peel strength but also the removability of the pressure sensitive adhesive tape by decreasing the stretch release strength.

In addition, the adhesive layers laminated on both sides of the substrate layer may have the chemical compositions equal to or different from each other, the adhesive powers equal to or different from each other, the thicknesses equal to or different from each other, or the colors equal to or different from each other. Accordingly, the characteristics of the adhesive layers may be different from each other by considering the use of the pressure sensitive adhesive tape. For example, when the pressure sensitive adhesive tape is used for fixing a hook on the bathroom wall, the adhesive power of the adhesive layer contacting with the moist bathroom wall may be high and the adhesive power of the adhesive layer contacting with the relatively less moist plastic hook adherend may be low. Furthermore, it is possible to provide a convenience to users by differentiating the colors of the adhesive layers for indicating the adhesive face to be attached to the bathroom wall.

Meanwhile, when the adhesive power of the adhesive layer of the pressure sensitive adhesive tape is increased, the hardness of the adhesive layer itself decreases and the adhesive layer may do not maintain its shape and slide down. Therefore, the present invention makes the pressure sensitive adhesive tape maintain its shape by raising the hardness of the same while maintaining the characteristic of the adhesive layer by using the reinforcement in the substrate layer.

The reinforcement is used for improving the strength, the heat resistance, or the chemical resistance of the substrate layer, and it is not limited particularly if it can be used to the pressure sensitive adhesive tape. For example, fumed silica (hydrophobic fumed silica, AEROSIL® R 972 of Cosmos plastics & chemicals Co., Ltd. for a commercial example) or titanium dioxide (TiO₂, COTIOX KA-100 of Cosmo Chemical Co., Ltd. for a commercial example) may be used preferably. The content of the reinforcement may be preferably 5 to 15 wt % per the total weight of the substrate layer.

Furthermore, the elongation of the pressure sensitive adhesive tape according to the present invention may be preferably 1,500 to 3,500%. And, the tensile strength of the pressure sensitive adhesive tape according to the present invention may be 1 MPa to 10 MPa, preferably 3 MPa to 7 MPa, and more preferably 4 MPa to 6 MPa.

The substrate layer and the adhesive layer may be formed into a single layer or a plurality of layers respectively. The substrate layer may have the structure in which 1 to 6 partial substrate layers of 25 μm to 85 μm thickness are laminated, and the adhesive layer may have the structure in which 1 to 3 partial adhesive layers of 10 μm to 80 μm thickness are laminated.

When the thin partial substrate layers and partial adhesive layers are laminated like above, it is possible to prevent the elasticity from excessively increasing in comparison with the substrate layer or the adhesive layer formed into a single layer of the same thickness.

The thermoplastic synthetic rubber used as the main component in the substrate layer and the adhesive layer is not limited particularly if it can be used to the pressure sensitive adhesive tape, and a polystyrene copolymer may be used preferably. Furthermore, the thermoplastic synthetic rubber of the partial substrate layer and the thermoplastic synthetic rubber of the partial adhesive layer may be equal to or different from each other. The polystyrene copolymer may include a polybutadiene block or a polyisoprene block in addition to a polystyrene block, and, specifically, it may be a styrene-isoprene-styrene rubber (SIS rubber, SIS 1221 of Oretel polymer Co., Ltd., Vector 4411A or Vector 4113A of TSRC/Dexco Co., Ltd. for a commercial example), a styrene-ethylene/butylene-styrene rubber (SEBS rubber, G1652M or G1657M of Kraton Co., Ltd. for a commercial example), a styrene-butadiene-styrene rubber (SBS rubber, Tufprene™ A of Asahi kasei Co., Ltd. for a commercial example) and so on.

Furthermore, the substrate layer or the adhesive layer may further include one or more additives selected from the group consisting of a tackifier, a UV stabilizer, an antioxidant, and a toning agent with necessity.

The tackifier is for increasing the adhesive power of the pressure sensitive adhesive tape, and it is not limited particularly if it can be used to the pressure sensitive adhesive tape. Preferably, it may be a rosin acid, a rosin ester, a terpene phenol resin, a hydrocarbon resin, a cumarone indene resin, and so on. As commercially usable tackifiers, there are Haritack PH, Haritack F85, Haritack F105, and so on of Harima chemical Co., Ltd. Particularly, the peel strength of the pressure sensitive adhesive tape according to the present invention disclosed above may be controlled by the amount of the tackifier used.

The UV stabilizer is for inhibiting the decrease of weather resistance, the crack generation, the yellowing, and the like of the pressure sensitive adhesive tape caused by a UV ray, and it is not limited particularly if it can be used to the pressure sensitive adhesive tape. As commercially usable UV stabilizers, there are Tlnuvin series of BASF Co., Ltd. (for example, Tlnuvin 1577 ED, Tlnuvin 400, Tlnuvin 405, Tlnuvin 460, Tlnuvin 477 and Tlnuvin 479).

The antioxidant is for preventing the thermoplastic synthetic rubber from oxidation by the action of oxygen, and it is not limited particularly if it can be used to the pressure sensitive adhesive tape. As commercially usable UV stabilizers, there are Irganox series (for example, Irganox® 245, Irganox® 415, Irganox® 1010, Irganox® 1076, Irganox® 1135, Irganox® 1081, Irganox® 3114 and Irganox® 3790).

The toning agent is for realizing a color, and it is not limited particularly if it can be used to the pressure sensitive adhesive tape and oil-based paints (for commercial example, oil-based toning agent white and blue of NOROO paint & coatings Co., Ltd.) may be used.

Furthermore, the pressure sensitive adhesive tape according to the present invention may further include a non-adhesive tap which covers part of the surface of at least one adhesive layer. The non-adhesive tap is the part which can be caught by hand when the pressure sensitive adhesive tape is eliminated from the adherend, and it is possible to increase the grip feeling by minimizing the adhesiveness. The non-adhesive tap is not limited particularly if it is a material having low adhesiveness. For example, a synthetic rubber or a paper may be used. Furthermore, it is preferable that the non-adhesive tap is formed at the end portion of the adhesive layer.

Furthermore, the pressure sensitive adhesive tape according to the present invention may be used for fixing a hook on the bathroom wall and the like by attaching the same on the wall and attaching the hook thereon. The hook has a curved end to hang articles such as keys or clothes thereon, and, generally, it comprises a hook part comprising a hook on which the articles are hanged and an adhesion part for attaching the hook part to the adherend surface. The pressure sensitive adhesive tape according to the present invention is attached to the adhesion part for fixing the hook on the bathroom wall face and the like, and the hook can be separated from the wall face by a method of stretching the pressure sensitive adhesive tape as disclosed above.

The shape of the hook is not limited if it can be attached to the pressure sensitive adhesive tape according to the present invention, and the shape of the hook part and the adhesion part may be variously selected according to the kind of the article to be hanged thereon or the convenience of use. For example, the hook disclosed in Korea Patent Application No. 10-2013-0139020 may be used, and, in this case, there is an advantage in that the pressure sensitive adhesive tape can be separated without touching the pressure sensitive adhesive tape directly and the hook separated is reusable.

Furthermore, the present invention provides a preparation method of the pressure sensitive adhesive tape, comprising the steps of:

1) preparing a substrate layer of 25 μm to 500 μm thickness from a composition comprising a thermoplastic synthetic rubber and a reinforcement with a coating method,

2) preparing adhesive layers of 10 μm to 240 μm thickness from a composition comprising a thermoplastic synthetic rubber and a filler with a coating method, and

3) laminating the adhesive layers on both sides of the substrate layer.

Furthermore, when the substrate layer and the adhesive layer are formed into a plurality of layers, the preparation method may include the steps of:

1) preparing partial substrate layers of 25 μm to 85 μm thickness from a composition comprising a thermoplastic synthetic rubber and a reinforcement with a coating method,

2) preparing partial adhesive layers of 10 μm to 80 μm thickness from a composition comprising a thermoplastic synthetic rubber and a filler with a coating method,

3) preparing a substrate layer by laminating 1 to 6 partial adhesive layers, and

4) preparing adhesive layers by laminating 1 to 3 partial adhesive layers respectively on both sides of the substrate layer.

### Effects of the Invention

The pressure sensitive adhesive tape according to the present invention is characterized in that it has an excellent adhesive power and high resistance to moisture and is easily peeled from an adherend because of filler included in the adhesive layers.

### BRIEF DESCRIPTION OF THE DRAWINGS

FIG. 1 is a schematic drawing illustrating the structure and the principle of the pressure sensitive adhesive tape of the present invention.

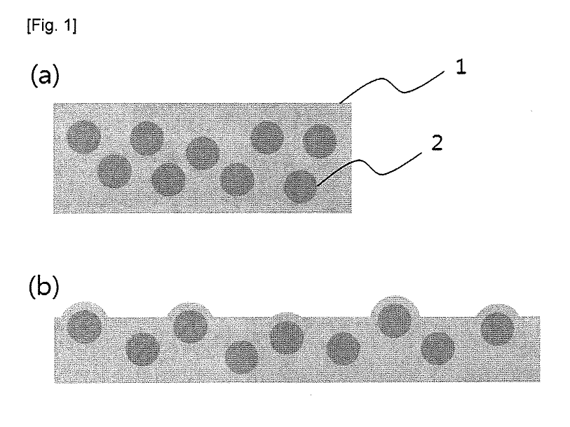

### DETAILED DESCRIPTION OF THE EMBODIMENT

Hereinafter, preferable examples and comparative examples are presented for understanding the present invention. However, the following examples are only for illustrating the present invention and the present invention is not limited to or by them.

### EXAMPLES

Step 1) Preparation of Partial Substrate Layers

After mixing 11.4 g of Vector 4411A, 45.6 g of Vector 4113A, 43 g of tackifier (Haritack PH), 1 g of antioxidant (Irganox® 1010), 1 g of UV stabilizer (Tinuvin 477), 0.5 g of oil-based toning agent (white), 10 g of hydrophobic dry silica (AEROSIL® R 972), 7 g of titanium oxide (COTIOX KA-100), and 85 g of toluene, the partial substrate layer 1 having the thickness of 75 μm was prepared from the mixture by a hot air drying method.

Furthermore, the partial substrate layers 2 to 4 were prepared by the same method above, except changing their composition ratios as illustrated in the following Table 1.

TABLE 1

| | Partial substrate layers | | | | | | | |
|---|---|---|---|---|---|---|---|---|
| | 1 | | 2 | | 3 | | 4 | |
| Vector 4411A | 11.4 | g | 60 | g | 10.6 | g | 31.8 | g |
| Vector 4113A | 45.6 | g | — | | 42.4 | g | 21.2 | g |
| Haritack PH | 43 | g | 40 | g | 47 | g | 47 | g |
| Irganox 1010 | 1 | g | 1 | g | 1 | g | 1 | g |
| Tinuvin 477 | 1 | g | 1 | g | 1 | g | 1 | g |
| Oil-based | 0.5 | g | 0.5 | g | 0.5 | g | 0.5 | g |
| toning agent | (white) | | (white) | | (white) | | (white) | |
| AEROSIL R972 | 10 | g | 10 | g | 10 | g | 10 | g |
| COTIOX KA-100 | 7 | g | 7 | g | 7 | g | 7 | g |
| Toluene | 85 | g | 65 | g | 70 | g | 70 | g |

Step 2) Preparation of Partial Adhesive Layers

After mixing 45 g of SIS 1221, 55 g of tackifier (Haritack PH), 1 g of antioxidant (Irganox® 1010), 1 g of UV stabilizer (Tinuvin 477), 0.05 g of oil-based toning agent (blue), 10 g of aluminum hydroxide (BF 083), and 85 g of toluene, the partial adhesive layer 1 having the thickness of 85 μm was prepared from the mixture by a hot air drying method.

Furthermore, the partial adhesive layers 2 to 4 were prepared by the same method above, except changing their composition ratios as illustrated in the following Table 2.

TABLE 2

| | Partial adhesive layers | | | | |
|---|---|---|---|---|---|
| | 1 | | 2 | 3 | 4 |
| SIS1221 | 45 | g | 38 g | 45 g | 40 g |
| Haritack PH | 55 | g | 62 g | 55 g | 60 g |
| Irganox 1010 | 1 | g | 1 g | 1 g | 1 g |
| Tinuvin 477 | 1 | g | 1 g | 1 g | 1 g |
| Oil-based | 0.05 | g | 3 g | 3 g | 3 g |
| toning agent | (blue) | | (white) | (white) | (white) |
| BF083 | 10 | g | 10 g | 10 g | 5 g |
| Toluene | 85 | g | 70 g | 70 g | 70 g |

Step 3) Preparation of Pressure Sensitive Adhesive Tapes

After preparing a substrate layer by laminating the partial substrate layers, the pressure sensitive adhesive tapes were prepared by laminating the partial adhesive layers on both faces of the substrate layer as disclosed in the following Table 3.

TABLE 3

| | | | Thickness |
|---|---|---|---|
| | | | of the |
| | Adhesive layer | Substrate layer | layers |
| Example 1 | Partial adhesive layer 1 | Partial substrate layer 1 | 640 μm |
| | (75 μm × 4) | (85 μm × 2) | |
| Example 2 | Partial adhesive layer 2 | Partial substrate layer 2 | 640 μm |
| | (75 μm × 4) | (85 μm × 2) | |
| Example 3 | Partial adhesive layer 3 | Partial substrate layer 3 | 640 μm |
| | (75 μm × 4) | (85 μm × 2) | |
| Example 4 | Partial adhesive layer 4 | Partial substrate layer 4 | 640 μm |
| | (75 μm × 4) | (85 μm × 2) | |

### Comparative Examples

The pressure sensitive adhesive tapes of Comparative Examples 1 to 4 were prepared by the same method as in Example above, except that the filler (BF083) was not used in the preparation of the partial adhesive layer.

### Experimental Example

The properties of the pressure sensitive adhesive tapes prepared in Example were measured by the following methods.

1) Measurement of 180° Peel Strength

The pressure sensitive adhesive tape was cut into 20 mm width and a PET film of 25 μm thickness was attached to the opposite face of the measuring face thereof. The measuring face of the pressure sensitive adhesive tape was attached to a SUS adherend and the film was pressed by rolling a 2 kg roller back and forth once thereon. After 30 mins passed, the peel strength was measured by peeling the film 180° with the speed of 300 mm/min. At this time, the measurement was carried out by using a universal testing machine (UTM, LR5K plus of AMETEK company Co., Ltd.).

2) Measurement of Tensile Strength and Elongation

The pressure sensitive adhesive tape was cut into 20 mm×60 mm size and both ends of the same were clamped in the UTM so that the measuring part where substantial deformation occurred was 20 mm×20 mm size. The tensile strength and the elongation were measured by pulling the tape with the speed of 300 mm/min.

3) Comparison of Stretch Release Strength (Removability)

The pressure sensitive adhesive tape was cut into 20 mm×60 mm size and glass adherends were attached to both faces of the measuring part of 20 mm×40 mm. After 30 mins passed, the upper part (20 mm×20 mm) of the pressure sensitive adhesive tape was clamped in the UTM and the force when the pressure sensitive adhesive tape was peeled between the glass adherends was measured.

4) Test of Moisture Resistance

The pressure sensitive adhesive tape was cut into 25 mm×25 mm size and attached to a SUS adherend by rolling a 2 kg roller back and forth once thereon. Subsequently, the specimen was loaded by a 1 kg weight and left in a thermo-hygrostat of 35° C. and 90% RH condition for 500 hrs. After eliminating the weight, whether the specimen was dropped out from the SUS adherend or not was checked.

The results of the measurements are listed in the following Table 4.

TABLE 4

| | | | | Stretch release strength test | | |
|---|---|---|---|---|---|---|
| | | | | (gf) | | |
| | | | | Before adding | After adding | |
| | | Tensile | | filler | filler | |
| | Peel strength | strength | Elongation | (Comparative | (Examples 1 | Moisture |
| | (gf/20 mm) | (MPa) | (%) | Examples 1 to 4) | to 4) | resistance |
| Example 1 | 16,000 | 4.74 | 2800 | 3140 | 2600 | pass¹⁾ |
| Example 2 | 20,000 | 5.41 | 1700 | 3320 | 2850 | pass |
| Example 3 | 16,500 | 4.90 | 3200 | 3180 | 2690 | pass |
| Example 4 | 19,000 | 5.30 | 1700 | 3230 | 2800 | pass |

¹⁾pass: specimen was not dropped out from the SUS adherend

As shown in Table 4, the pressure sensitive adhesive tapes according to the present invention were not dropped out in the moisture resistance test because their peel strength was high. Furthermore, in comparison to the pressure sensitive adhesive tapes of Comparative Examples to which the filler was not added, it is recognizable that the pressure sensitive adhesive tapes according to the present invention show low stretch release strength, specifically, less than 3,000 gf, and are easy to peel.

Therefore, it is recognizable that the pressure sensitive adhesive tape according to the present invention is superior in moisture resistance because of its high peel strength and is easy to eliminate because of it low stretch release strength due to addition of the filler.

1. A pressure sensitive adhesive tape, comprising a substrate layer and adhesive layers laminated on both faces of the substrate layer, wherein
the thickness of the substrate layer is 25 μm to 500 μm and the substrate layer comprises a thermoplastic synthetic rubber and a reinforcement,
the thickness of each adhesive layer is 10 μm to 240 μm respectively and the substrate layer comprises a thermoplastic synthetic rubber and a filler,
the filler is a particle having the diameter of 0.01 μm to 120 μm, and
the peel strength of the pressure sensitive adhesive tape is 6,000 to 25,000 gf/20 mm.

2. The pressure sensitive adhesive tape according to claim 1, wherein the filler is made of a glass, a metal, an inorganic particle, aluminum hydroxide, polyethylene, or polypropylene.

3. The pressure sensitive adhesive tape according to claim 1, wherein the content of the filler is 5 to 15 wt % per the total weight of the adhesive layer.

4. The pressure sensitive adhesive tape according to claim 1, wherein the peel strength of the pressure sensitive adhesive tape is 10,000 to 24,000 gf/20 mm.

5. The pressure sensitive adhesive tape according to claim 1, wherein the stretch release strength of the pressure sensitive adhesive tape is 3,000 gf or less.

6. The pressure sensitive adhesive tape according to claim 1, wherein the adhesive layers laminated on both sides of the substrate layer has the chemical compositions equal to or different from each other, the adhesive powers equal to or different from each other, the thicknesses equal to or different from each other, or the colors equal to or different from each other.

7. The pressure sensitive adhesive tape according to claim 1, wherein the reinforcement is fumed silica or titanium oxide.

8. The pressure sensitive adhesive tape according to claim 1, wherein the content of the reinforcement is 5 to 15 wt % per the total weight of the substrate layer.

9. The pressure sensitive adhesive tape according to claim 1, wherein the elongation of the pressure sensitive adhesive tape is 1,500 to 3,500%.

10. The pressure sensitive adhesive tape according to claim 1, wherein the tensile strength of the pressure sensitive adhesive tape is 1 MPa to 10 MPa.

11. The pressure sensitive adhesive tape according to claim 1, wherein the substrate layer has the structure in which 1 to 6 partial substrate layers of 25 μm to 85 μm thickness are laminated.

12. The pressure sensitive adhesive tape according to claim 1, wherein the adhesive layer has the structure in which 1 to 3 partial adhesive layers of 10 μm to 80 μm thickness are laminated.

13. The pressure sensitive adhesive tape according to claim 1, wherein the thermoplastic synthetic rubber is a polystyrene copolymer.

14. The pressure sensitive adhesive tape according to claim 13, wherein the polystyrene copolymer comprises a polybutadiene block or a polyisoprene block in addition to a polystyrene block.

15. The pressure sensitive adhesive tape according to claim 1, wherein the substrate layer or the adhesive layer further comprises one or more additives selected from the group consisting of a tackifier, a UV stabilizer, an antioxidant, and a toning agent.

16. The pressure sensitive adhesive tape according to claim 1, wherein the pressure sensitive adhesive tape further comprises a non-adhesive tap which covers part of the surface of at least one adhesive layer.
